(19) United States
(12) Patent Application Publication
(10) Pub. No.: US 2013/0246597 A1
(43) Pub. Date: Sep. 19, 2013

(54) PROCESSOR, COMPUTER READABLE RECORDING MEDIUM RECORDING PROGRAM THEREIN, AND PROCESSING SYSTEM

(71) Applicant: FUJITSU LIMITED, Kawasaki-shi (JP)

(72) Inventors: Ken Iizawa, Yokohama (JP); Toshihiro Ozawa, Yokohama (JP); Yasuo Noguchi, Kawasaki (JP); Kazuichi Oe, Yokohama (JP); Munenori Maeda, Yokohama (JP); Kazutaka Ogihara, Hachioji (JP); Masahisa Tamura, Kawasaki (JP); Tatsuo Kumano, Kawasaki (JP); Jun Kato, Kawasaki (JP)

(73) Assignee: FUJITSU LIMITED, Kawasaki-shi (JP)

(21) Appl. No.: 13/736,228

(22) Filed: Jan. 8, 2013

(30) Foreign Application Priority Data
Mar. 15, 2012 (JP) 2012-058960

(51) Int. Cl. H04L 29/08

(52) U.S. Cl. CPC H04L 29/08702
USPC 709/223

(57) ABSTRACT

There are provided a processing unit that processes received requests, a storage unit that stores order information added to the last-processed request among the requests processed by the processing unit as final request information, a determination unit that determines whether the received request has been processed with reference to the final request information based on the order information added to the received request, and a control unit that, when the determination unit determines that the received request has been processed, prevents the received request from being processed by the processing unit, thereby preventing overlapped execution of a command.

### CROSS-REFERENCE TO RELATED APPLICATION

This application is based upon and claims the benefit of priority of the prior Japanese Patent Application No. 2012-058960, filed on Mar. 15, 2012, the entire contents of which are incorporated herein by reference.

### FIELD

The embodiment discussed herein relates to a processor, a computer readable recording medium recording a program therein, and a processing system.

### BACKGROUND

For example, data is stored in units of object in a server in a client server storage system.

Objects are copied and stored in a plurality of servers for redundancy. Among a group of servers holding the copies, a first server to which a client accesses is called primary server and other servers are called backup server. When the primary server breaks down, one of the backup servers is a new primary server.

FIGS. 14 and 15 are diagrams for explaining processing in a conventional storage system, respectively. Two servers S01, S02 and a client C01 are illustrated in FIGS. 14 and 15.

In the storage system exemplified in FIG. 14, the client C01 transmits a request for an object 0 (obj0) to the server S01 as a primary server (see arrow A1), and the server S01 executes a command (an operation for the object) designated by the request. When completing the execution of the command, the server S01 returns a completion notification and an execution result as a reply to the client C01 (see arrow A4). Further, the primary server S01 forwards the request for the object 0 (obj0) received from the client C01 to the backup server S02 (see arrow A2), and the backup server S02 having executed the request transmits a reply to the primary server S01 (see arrow A3).

Here, it is assumed that the primary server S01 breaks down while executing a command. That is, there will be considered an example in which the primary server S01 breaks down between reception of a request from the client C01 and return of a reply to the client C01.

As illustrated in FIG. 15, the client C01 transmits a request for the object 0 (obj0) to the server S01 as a primary server (see arrow B1).

The primary server S01 forwards the request received from the client C01 to the backup server S02 (see arrow B2), and the backup server S02 having executed the request transmits a reply to the primary server S01 (see arrow B3). At this point, when the primary server S01 breaks down (see arrow B4), the primary server S01 cannot transmit a reply to the client C01 (see arrow B5).

When detecting that the request to the primary server S01 times out, the client C01 retries the request. That is, the request for the object (obj0) is retransmitted (see arrow B6). The retry is transmitted to the server S02 different from the time-out server S01. In the following, the new primary server S02 is called new primary server S02 and the time-out primary server S01 is called old primary server S01.

Here, a command is either forwarded or not forwarded from the old primary server S01 to the new primary server S02 depending on a timing when the old primary server S01 breaks down. That is, a command to be retired from the client C01 either has been executed or has not been executed in the new primary server S02.

However, any commands should not be executed in an overlapped manner like a non-idempotent processing such as INCREMENT. Thus, it is necessary to distinguish whether the new primary server S2 retries an executed command or retries an unexecuted command, and not to re-execute an executed command.

In a conventional client server system, an identifier is added to a request transmitted from the client C01 and an identifier of an executed request is recorded as executed in the server. A size of the executed request has a fixed length and the execution record of old requests disappears. When an identifier of a received request is already registered in the executed list, the servers S01 and S02 do not execute the request, thereby preventing the command from being executed in an overlapped manner.
[Patent Literature 1] Japanese Laid-open Patent Publication No. 2011-76304

However, for example, when the new primary server S02 is in a high load state, that is, when the number of executed commands for each unit time is large, an identifier of a recently-executed request also disappears from the executed list. Thus, when the client C01 transmits a retry to the new primary server S02 in this state, there is a concern that the new primary server S02 executes an executed command in an overlapped manner.

### SUMMARY

Therefore, the processor includes a processing unit that processes received requests, a storage unit that stores order information added to the last-processed request among the requests processed by the processing unit as final request information, a determination unit that determines whether the received request has been processed with reference to the final request information based on the order information added to the received request, and a control unit that, when the determination unit determines that the received request has been processed, prevents the received request from being processed by the processing unit.

A computer readable recording medium records a program therein, and the program causes a computer to execute the processing of storing order information added to the last-processed request among processed requests as final request information in a storage unit, determining whether the received request has been processed with reference to the final request information based on the order information added to the received request, and when the received request is determined as processed, preventing the received request from being processed.

Furthermore, the processing system includes a request transmission unit that adds order information indicating an order of requests to a request and transmits the request, a processing unit that processes received requests, a storage unit that stores the order information added to the last-processed request among the requests processed by the processing unit as final request information, a determination unit that determines whether the received request has been processed with reference to the final request information based on the order information added to the received request, and a control unit that, when the determination unit determines that the received request has been processed, prevents the received request from being processed by the processing unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a structure of an exemplary storage system according to an embodiment;

FIG. 2 is a diagram exemplifying a hardware structure of a server in the exemplary storage system according to the embodiment;

FIG. 3A is a diagram for explaining control information in the exemplary storage system according to the embodiment;

FIG. 3B is a diagram for explaining the control information in the exemplary storage system according to the embodiment;

FIG. 3C is a diagram for explaining the control information in the exemplary storage system according to the embodiment;

FIG. 4 is a flowchart for explaining processing by a control unit in the exemplary storage system according to the embodiment;

FIG. 5 is a diagram for explaining processing by the exemplary storage system according to the embodiment;

FIG. 6 is a diagram for explaining processing by the exemplary storage system according to the embodiment;

FIG. 7 is a diagram for explaining processing by the exemplary storage system according to the embodiment;

FIG. 8 is a diagram for explaining processing by the exemplary storage system according to the embodiment;

FIG. 9 is a diagram for explaining processing by the exemplary storage system according to the embodiment;

FIG. 10 is a diagram for explaining processing by the exemplary storage system according to the embodiment;

FIG. 11 is a diagram for explaining processing by the exemplary storage system according to the embodiment;

FIG. 12 is a diagram for explaining processing by the exemplary storage system according to the embodiment;

FIG. 13 is a diagram for explaining processing by the exemplary storage system according to the embodiment;

FIG. 14 is a diagram for explaining processing in a conventional storage system; and

FIG. 15 is a diagram for explaining processing in the conventional storage system.

### DESCRIPTION OF EMBODIMENT

An embodiment for a processor, a program and a processing system will be described below with reference to the drawings. The embodiment described below is merely exemplary, and does not intend to eliminate applications of various variants or techniques not demonstrated in the embodiment. That is, the present embodiment can be variously modified and performed without departing from its scope. Further, in each figure, the embodiment can include not only the illustrated components but also other functions.

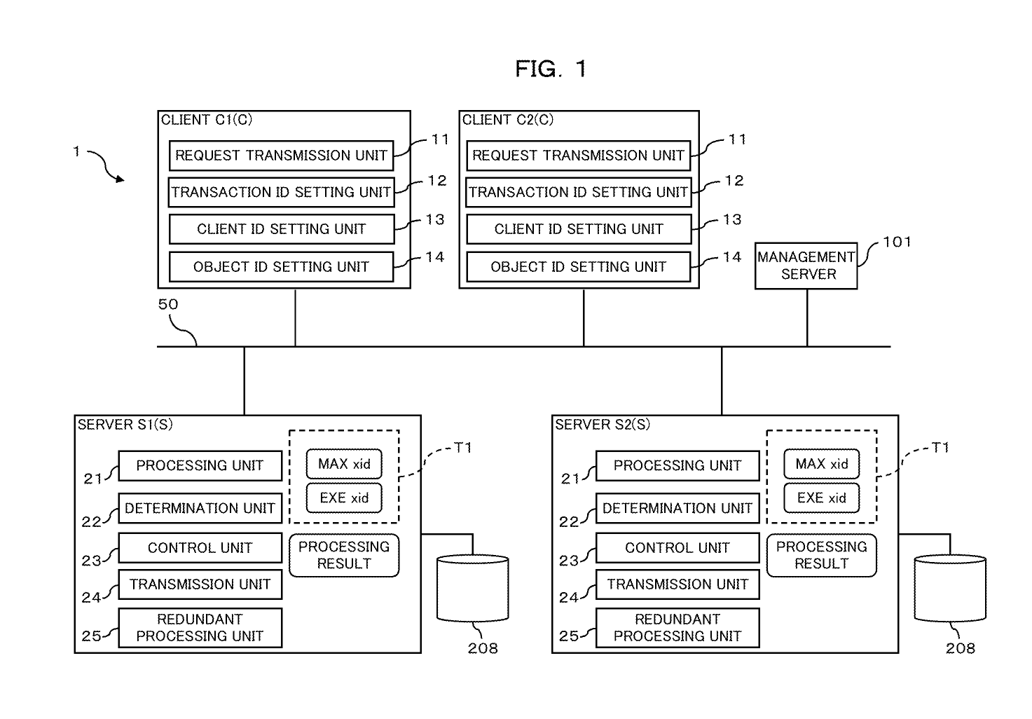

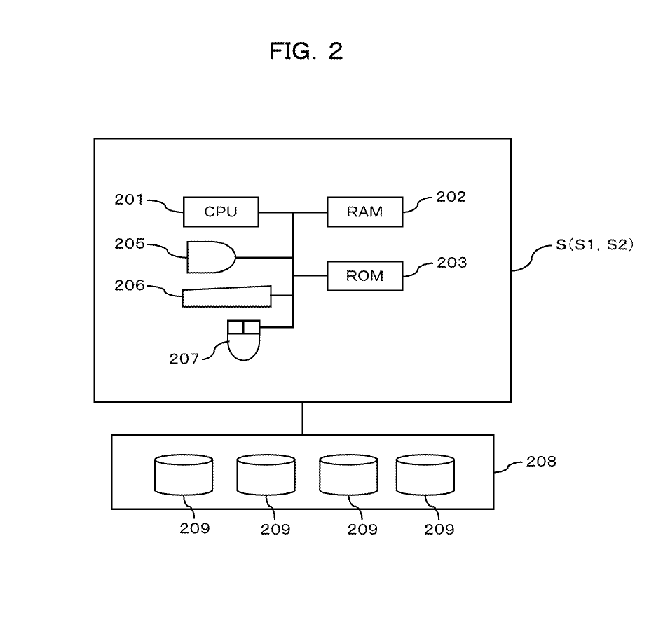

FIG. 1 is a diagram schematically illustrating a structure of an exemplary storage system 1 according to the embodiment, and FIG. 2 is a diagram exemplifying a hardware structure of a server thereof.

The storage system 1 is a client server system including a plurality of (two in the example illustrated in FIG. 1) servers S1, S2, one or more (two in the example illustrated in FIG. 1) clients C1, C2, and a management server 101.

The servers S1, S2, the clients C1, C2 and the management server 101 are connected in a mutually communicable manner via a network 50. The network 50 is a communication line such as LAN (Local Area Network).

The clients C1 and C2 are information processing devices, and perform various processing on data (objects) stored in storage areas provided in the servers S1 and S2. The clients C1 and C2 have the same structure. In the following, reference numerals C1 and C2 are used as reference numerals indicating clients when one of the clients needs to be specified, but a reference numeral C is used to designate a client.

The client C is a computer including CPU (Central Processing Unit), RAM (Random Access Memory) and ROM (Read Only Memory) (not illustrated), for example.

The client C includes the functions of a request transmission unit 11, a transaction ID setting unit 12, a client ID setting unit 13 and an object ID setting unit 14 as illustrated in FIG. 1.

The request transmission unit 11 generates a request of designating a command (an operation for an object) for the servers S1 and S2, and transmits it to a primary server in the servers S1 and S2. Note that, which is a primary server in the servers S1 and S2 is notified by the management server 101 described later, for example.

The transaction ID setting unit 12 sets a transaction ID (xid) as a unique identifier for each request generated by the request transmission unit 11. The transaction ID is order information indicating a request order of multiple requests. The transaction ID desirably uses a value increasing by a predetermined value (such as 1), or a monotonically-increasing value, for example. The transaction ID setting unit 12 increments the transaction ID each time the request transmission unit 11 generates and transmits a request.

Thereby, the transaction IDs are compared for their magnitude thereby to determine a processing order of the requests added with the transaction IDs. As a value of the transaction ID is smaller, its request is earlier in the processing order, and as a value of the transaction ID is larger, its request is later in the processing order.

The transaction ID setting unit 12 sequentially sets a monotonically-increasing transaction ID as a value indicating a transmission order for each request sequentially transmitted by the request transmission unit 11.

Note that, the transaction ID is not limited to a monotonically-increasing value, and can be changed as needed for execution. For example, a series of information such as a character string of alphabets, which is definite in an anteroposterior relationship, may be used. Further, the transaction ID setting unit 12 may set a transaction ID as processing order information indicating a processing order of requests in the server S, for example, instead of setting a transaction ID as transmission order information indicating a transmission order of requests, and can be modified as needed for execution.

The request transmission unit 11 adds a transaction ID set by the transaction ID setting unit 12 to a request for transmission.

The client ID setting unit 13 sets a client ID (cid) as a unique identifier indicating the client C for each request generated by the request transmission unit 11. For example, an identifier previously set for each client C is stored in a storage device (not illustrated) in the client C and the client ID setting unit 13 uses the identifier read from the storage device as a client ID.

The request transmission unit 11 also adds a client ID set by the client ID setting unit 13 to the request for transmission.

The object ID setting unit 14 sets an object ID (Oid) as a unique identifier for an object of each request generated by the request transmission unit 11. Note that, the object ID may employ any combination of alphanumeric characters, for example. Further, it is not limited thereto and may be changed as needed for execution.

The request transmission unit 11 also adds an object ID set by the object ID setting unit 14 to a request for transmission.

The management server 101 is an information processing device for operational management in the storage system 1, and is directed for acquiring and setting information on each server S1, S2. The management server 101 is also a computer including CPU, RAM or ROM (not illustrated), for example.

For example, the management server 101 monitors an operation state of the server S1 or the server S2, and detects an occurrence of a failure such as breakdown. Further, the management server 101 notifies, to each client C, which of the servers S1 and S2 is a primary server.

The servers S1 and S2 receive a request transmitted from the client C or the like, and execute a command (an operation for an object) designated by the request. In the present embodiment, the servers S1 and S2 are an information processing device (computer) including a storage server function, and manage a storage device 208, respectively. The servers S1 and S2 have the same structure. In the following, for the reference numerals indicating the servers, reference numerals S1 and S2 are employed for specifying one of multiple servers but a reference numeral S is used for any server.

The servers S1 and S2 are made redundant, and the same data as at least part of the data (objects) stored in the server S1 is also stored in the server S2.

In the present embodiment, it is assumed that the server S1 in the servers S1 and S2 is a primary server and the server S2 is a backup server. When the primary server S1 breaks down, the backup server S2 is a new primary server.

The server S includes a CPU 201, a RAM 202, a ROM 203, a display device 205, a keyboard 206 and a mouse 207 as illustrated in FIG. 2. Further, the storage device 208 is connected to the server S.

The storage device 208 is a RAID (Redundant Arrays of Inexpensive Disks) device, for example, and combines a plurality of HDDs (Hard Disk Drive) 209 to manage them as one redundant storage. Note that, a structure of the storage device 208 may be changed as needed. For example, the number of HDDs 209 may be variously changed for execution. Further, other storage devices such as SSD (Solid State Drive) may be provided instead of the HDDs 209.

The display device 205 is a liquid crystal display, for example, and displays thereon various messages or calculation results in response to operations. The keyboard 206 and the mouse 207 are input devices, and an operator uses the input devices to perform various input operations.

The ROM 203 is a storage device for storing therein programs or various items of data executed by the CPU 201. The RAM 202 is a storage area for temporarily storing various items of data or programs, and when the CPU 201 executes a program, temporarily stores and develops data or programs for use. Further, the RAM 202 stores therein control information T1 created by a determination unit 22 or processing results by a processing unit 21 described later.

The CPU 201 is a processor for performing various controls or calculations, and realizes various functions by executing the programs stored in the ROM 203. That is, the CPU 201 functions as the processing unit 21, the determination unit 22, a control unit 23, a transmission unit 24 and a redundant processing unit 25 as illustrated in FIG. 1

Note that, the programs for realizing the functions of the processing unit 21, the determination unit 22, the control unit 23, the transmission unit 24 and the redundant processing unit 25 are provided to be recorded in a computer readable recording medium such as flexible disk, CD (such as CD-ROM, CD-R or CD-RW), DVD (such as DVD-ROM, DVD-RAM, DVD-R, DVD+R, DVD-RW, DVD+RW or HD DVD), Blu-ray disk, magnetic disk, optical disk or magnetooptical disk. Then, the computer reads the programs from the recording medium to forward them to an internal storage device or external storage device for storage. Further, the programs may be recorded in a storage device (recording medium) such as magnetic disk, optical disk or magnetooptical disk to be provided from the storage device to the computer via a communication path.

When the functions of the processing unit 21, the determination unit 22, the control unit 23, the transmission unit 24 and the redundant processing unit 25 are realized, the programs stored in the internal storage device (the RAM 202 or the ROM 203 in the present embodiment) are executed by a microprocessor (the CPU 201 in the present embodiment) in the computer. At this time, the computer may read and execute the programs recorded in the recording medium.

Similarly, the client C is also configured such that the CPU in the information processing device executes the programs to function as the request transmission unit 11, the transaction ID setting unit 12, the client ID setting unit 13 and the object ID setting unit 14 described above.

The programs for realizing the functions of the request transmission unit 11, the transaction ID setting unit 12, the client ID setting unit 13 and the object ID setting unit 14 are also provided to be recorded in a computer readable recording medium such as flexible disk, CD (such as CD-ROM, CD-R or CD-RW), DVD (such as DVD-ROM, DVD-RAM, DVD-R, DVD+R, DVD-RW, DVD+RW or HD DVD), Blu-ray disk, magnetic disk, optical disk or magnetooptical disk. The computer reads the programs from the recording medium to forward them to an internal storage device or external storage device for storage. The programs may be recorded in a storage device (recording medium) such as magnetic disk, optical disk, magnetooptical disk, and may be provided from the storage device to the computer via a communication path.

When the functions of the request transmission unit 11, the transaction ID setting unit 12, the client ID setting unit 13 and the object ID setting unit 14 are realized, the programs stored in the internal storage device (the RAM or ROM (not illustrated) in the client C in the present embodiment) are executed by a microprocessor (the CPU in the client C in the present embodiment) in the computer. At this time, the programs recorded in the recording medium may be read and executed by the computer.

Note that, in the present embodiment, the computer is a concept including hardware and operating system, and means hardware operating under control of the operating system. Further, when hardware is operated only by an application program without the need of an operating system, the hardware itself corresponds to the computer. The hardware includes at least a microprocessor such as CPU, and a unit that reads computer programs recorded in the recording medium, and in the present embodiment, the servers S1, S2 or the clients C1, C2 have the functions of the computer.

The processing unit 21 processes a received request. That is, the processing unit 21 executes a command designated by a request. Further, the processing unit 21 stores a command execution result in the RAM 202 or the storage device 208. That is, the RAM 202 or the storage device 208 functions as a processing result storage unit that stores the request processing result by the processing unit 21.

The processing unit 21 executes the received requests in ascending order of value of a transaction ID added to a request.

The determination unit 22 manages the control information T1, and determines whether the received request has been processed with reference to the control information T1 based on the transaction ID added to the received request.

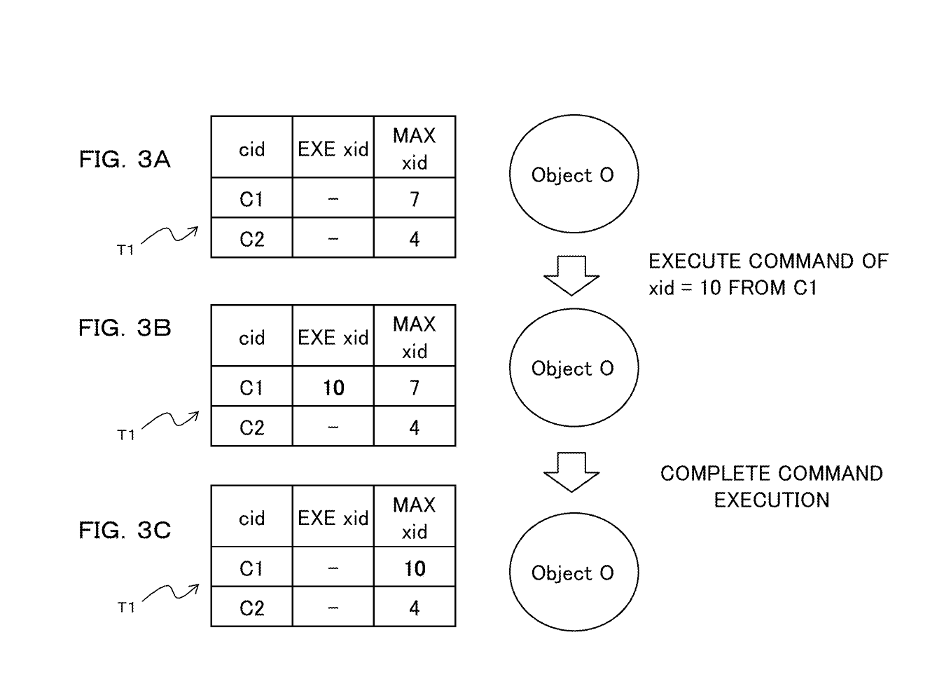

FIGS. 3A, 3B and 3C are diagrams for explaining the control information T1 in the exemplary storage system 1 according to the embodiment, respectively.

The control information T1 is configured such that a client ID (cid), an executing transaction ID (EXE xid) and a maximum executed transaction ID (MAX xid) are mutually associated as illustrated in FIGS. 3A, 3B and 3C. Further, a combination of client ID, executing transaction ID and maximum executed transaction ID is created for each object. That is, the combination of client ID, executing transaction ID and maximum executed transaction ID is created in association with an object ID. For example, the determination unit 22 creates the control information T1.

The client ID indicates a client C as a transaction issue source.

The executing transaction ID is a transaction ID of a transaction (command) being executed (processed) by the processing unit 21. The determination unit 22 stores the transaction ID of the transaction being executed by the processing unit 21 as an executing transaction ID. Further, when the execution of the transaction completes and the processing unit 21 executes a next transaction, the determination unit 22 updates the executing transaction ID by a transaction ID of a transaction to be newly executed.

The maximum executed transaction ID is a transaction ID of the last-executed transaction among the transactions executed by the server S.

In the storage system 1, as described above, the transaction ID setting unit 12 in each client C sequentially sets monotonically-increasing transaction IDs for a plurality of requests to be transmitted. Thus, for the requests to be continuously transmitted from the client C, a transaction ID of a later-issued request is larger than a transaction ID of a previously-issued request. Then, in the server S, a value of the transaction ID of the request last received and processed is the largest.

When the processing unit 21 completes processing the command for the transaction, the determination unit 22 stores the value of the executing transaction ID for the request being processed as a maximum executed transaction ID in the control information T1. That is, when the processing unit 21 switches a request to be processed, the determination unit 22 updates the value of the executing transaction ID, and stores the value stored as the executing transaction ID before the update as a maximum executed transaction ID. That is, when the execution of the transaction completes, the determination unit 22 uses the value of the executing transaction ID to update the value of the maximum executed transaction ID.

For example, the state exemplified in FIG. 3A indicates that for an object with an object ID of “0”, a transaction ID of a request transmitted from the client C1 and last processed is “7”. Further, it indicates that a transaction ID of a request transmitted from the client C2 and last processed is “4” and no request being executed by the processing unit 21 is present.

In the state exemplified in FIG. 3A, when the processing unit 21 receives a request with a transaction ID of “10” (xid=10) from the client C1 and starts to process the received request, the determination unit 22 stores “10” as an executing transaction ID for the client C1 in the control information T1 as illustrated in FIG. 3B.

Thereafter, when the processing unit 21 completes processing the request for xid=10, the determination unit 22 updates the maximum executed transaction ID for the client C1 to “10” (MAX xid=10) as illustrated in FIG. 3C.

The determination unit 22 compares the transaction ID of the received request with the maximum executed transaction ID thereby to determine whether the received request has been processed by the processing unit 21.

Specifically, when the transaction ID of the received request is equal to or less than the maximum executed transaction ID, the determination unit 22 determines that the command for the request has been executed. Further, when the transaction ID of the received request is larger than the maximum executed transaction ID, the determination unit 22 determines that the command for the request has not been executed.

The determination unit 22 compares the transaction ID of the received request with the executing transaction ID thereby to determine whether the received request is being processed by the processing unit 21. Specifically, when the transaction ID of the received request is equal to the executing transaction ID, the determination unit 22 determines that the command for the request is being executed.

When the determination unit 22 determines that the received request has been executed or is being executed by the processing unit 21, the control unit 23 prevents the received request from being processed by the processing unit 21.

Specifically, when the determination unit 22 determines that the received request has been executed by the processing unit 21, the control unit 23 does not cause the processing unit 21 to process the command for the received request. Then, the transmission unit 24 transmits an execution result of the command stored in the RAM 202 or the like as a reply to the transmission source.

Further, when the determination unit 22 determines that the received request is being processed by the processing unit 21, the control unit 23 does not cause the processing unit 21 to process the command for the received request. Further, when the processing unit 21 completes processing the command for the request, the transmission unit 24 transmits the execution result as a reply to the transmission source.

When the transaction ID of the received request is equal to or less than the maximum executed transaction ID, the command for the request has been executed. Thus, the control unit 23 does not cause the processing unit 21 to process the command for the received request in order to prevent overlapped execution of the command.

The transmission unit 24 transmits the processing result or the like of the request as a reply to the transmission source of the request. For example, when the determination unit 22 determines that the received request has been executed, the transmission unit 24 transmits the processing result stored in the memory 202 or the like to the request source.

Further, when the determination unit 22 determines that the received request is being executed by the processing unit 21, the transmission unit 24 transmits the processing result to the request source after the processing unit 21 completes the processing.

The processing by the determination unit 22, the control unit 23 and the transmission unit 24 in each case will be described below.

(1) A case in which a transaction ID of a request transmitted from the client C is equal to an executing transaction ID (xid=EXE xid)

When the transaction ID of the received request is equal to the executing transaction ID, the determination unit 22 determines that the command for the request is being executed.

The control unit 23 does not cause the processing unit 21 to process the command for the received request in order to prevent overlapped execution of the executing command. The transmission unit 24 transmits the execution result of the command as a reply to the transmission source after the processing unit 21 completes the executing command.

(2) A case in which a transaction ID of a request transmitted from the client C is equal to or less than a maximum executed transaction ID (xid<=MAX xid)

When the transaction ID of the received request is equal to or less than the maximum executed transaction ID, the determination unit 22 determines that the command for the request has been executed.

The control unit 23 does not cause the processing unit 21 to process the command for the received request in order to prevent overlapped execution of the executed command. The transmission unit 24 transmits the execution result of the command stored in the RAM 202 or the like as a reply to the transmission source.

(3) A case in which a transaction ID of a request transmitted from the client C is larger than a maximum executed transaction ID (xid>MAX xid)

When the transaction ID of the received request is larger than the maximum executed transaction ID, the determination unit 22 determines that the command for the request has not been executed.

The control unit 23 causes the processing unit 21 to process the command for the received request. The transmission unit 24 transmits the execution result of the command as a reply to the transmission source after the processing unit 21 completes the command processing.

The redundant processing unit 25 makes at least part of data (objects) in the servers S redundant. Specifically, the primary server S1 forwards the request received from the client C to the backup server S2 to cause the backup server S2 as a forward destination to execute the request. Thereby, the state of the stored objects are matched between the server S1 and the server S2. Note that, a redundant method by the redundant processing unit 25 can be realized by use of known various functions, and a detailed explanation thereof will not be repeated.

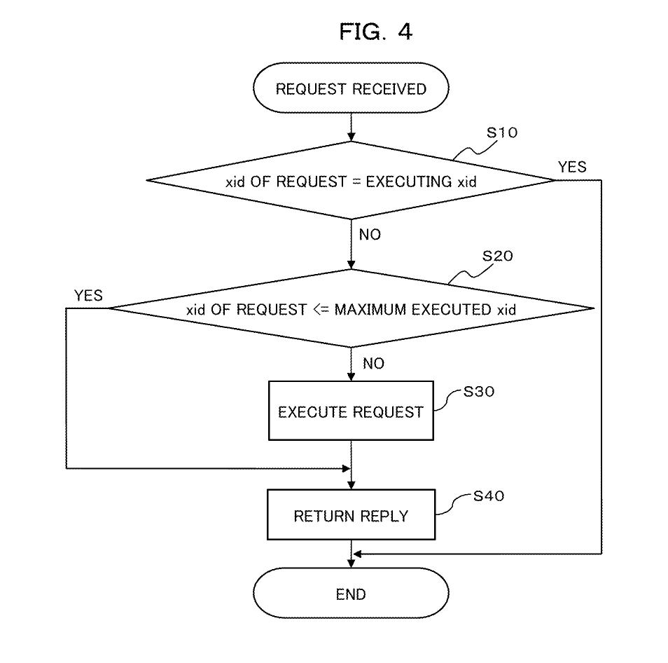

The processing by the control unit 23 in the exemplary storage system 1 according to the embodiment having the above structure will be described in a flowchart (steps S10 to S40) illustrated in FIG. 4.

When the server S receives a request from the client C, the determination unit 22 in the server S determines whether the received request has been processed with reference to the control information T1 based on the transaction ID added to the received request. That is, the determination unit 22 compares the transaction ID (Xid) added to the received request with an executing transaction ID (EXE xid) in the control information T1 (step S10).

When the transaction ID (Xid) added to the received request matches with the executing transaction ID (EXE xid) in the control information T1 (Xid=EXE xid) (see YES route in step S10), the determination unit 22 determines that the received request is being executed. The control unit 23 does not cause the processing unit 21 to process the command for the received request. After the processing unit 21 completes the executing command, the transmission unit 24 transmits the execution result of the command as a reply to the transmission source and terminates the processing. Thereby, the processing unit 21 does not execute the same command in an overlapped manner.

When the transaction ID added to the received request does not match with the executing transaction ID in the control information T1 (Xid=EXE xid) (see NO route in step S10), the determination unit 22 compares the transaction ID added to the received request with the maximum executed transaction ID in the control information T1. That is, the determination unit 22 confirms whether the transaction ID (Xid) added to the received request is equal to or less than the maximum executed transaction ID (MAX xid) in the control information T1 (Xid≦MAX xid) (step S20).

When the transaction ID (Xid) added to the received request is larger than the maximum executed transaction ID (MAX xid) (Xid>MAX xid) (see NO route in step S20), the determination unit 22 determines that the received request is to be executed. That is, the determination unit 22 determines that the received request has not been executed by the processing unit 21 and is not being executed by the processing unit 21. The control unit 23 causes the processing unit 21 to execute the command for the request (step S30).

When the processing unit 21 completes processing the command of the request, the transmission unit 24 returns the execution result as a reply to the transmission source of the request (step S40) and terminates the processing. That is, when the transmission source of the request is the client C, the transmission unit 24 transmits the reply to the client C. Further, when the request is forwarded from other server S, the transmission unit 24 transmits the reply to the server S as a forward source.

On the other hand, when the transaction ID (Xid) added to the received request is equal to or less than the maximum executed transaction ID (MAX xid) (Xid<=MAX xid) (see YES route in step S20), the processing proceeds to step S40. That is, the determination unit 22 determines that the received request has been executed by the processing unit 21 but its reply has not reached the transmission source.

The control unit 23 does not cause the processing unit 21 to process the command for the received request. Thereby, the processing unit 21 does not execute the same command in an overlapped manner. Further, the transmission unit 24 reads the execution result of the received request from the RAM 202 and returns it as a reply to the transmission source of the request.

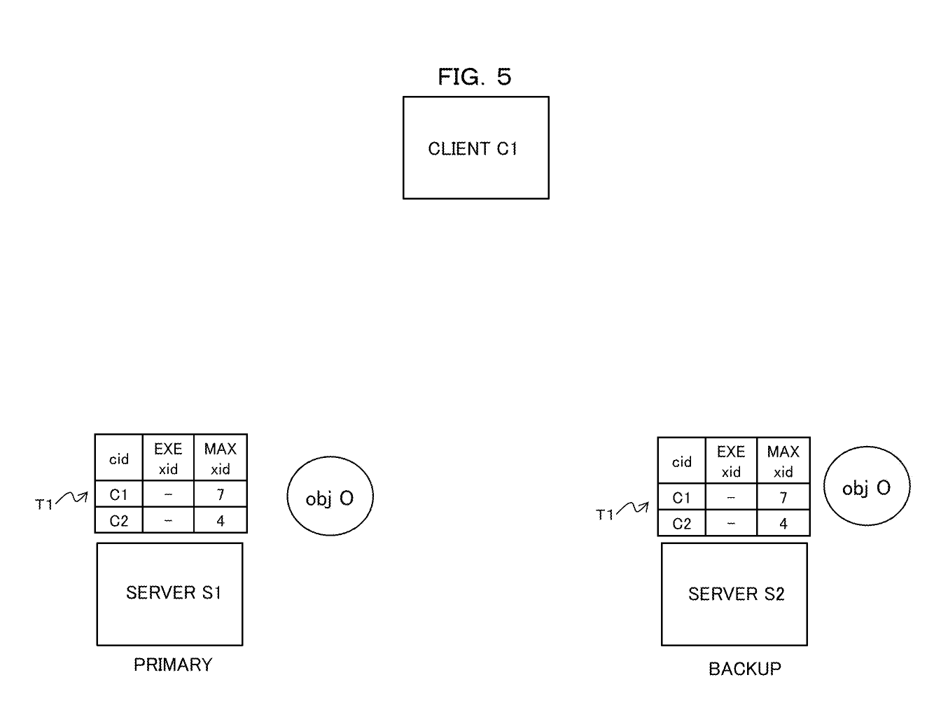

The processing by the exemplary storage system 1 according to the embodiment will be exemplified below with reference to FIGS. 5 to 13. In the present example, the client C1 makes a request for the object 0 (obj0;oid=0). Further, only the client C1, the servers S1, S2 and the control information T1 are illustrated for convenience in FIGS. 5 to 13, and the client C2, the management server 101, the network 50 and the like are not illustrated. Further, the detailed structure of the respective units are also not illustrated.

At first, there will be described processing when the server S does not break down with reference to FIGS. 5 to 10.

In the state illustrated in FIG. 5, no request being executed by the processing unit 21 for the object 0 is present in the servers S1 and S2. Further, in the servers S1 and S2, as illustrated in the control information T1, for the object 0, the maximum execution transaction ID for the client C1 is 7 (MAX xid=7) and the maximum executed transaction ID for the client C2 is 4 (MAX xid=4).

In the state illustrated in FIG. 5, a request (xid=10) for an INCREMENT command for the object 0 is issued from the client C1 to the primary server S1.

In the primary server S1 having received the request (xid=10), the determination unit 22 compares the transaction ID (Xid=10) added to the request with the executing transaction ID (EXE xid) or the maximum executed transaction ID (MAX xid) in the control information T1.

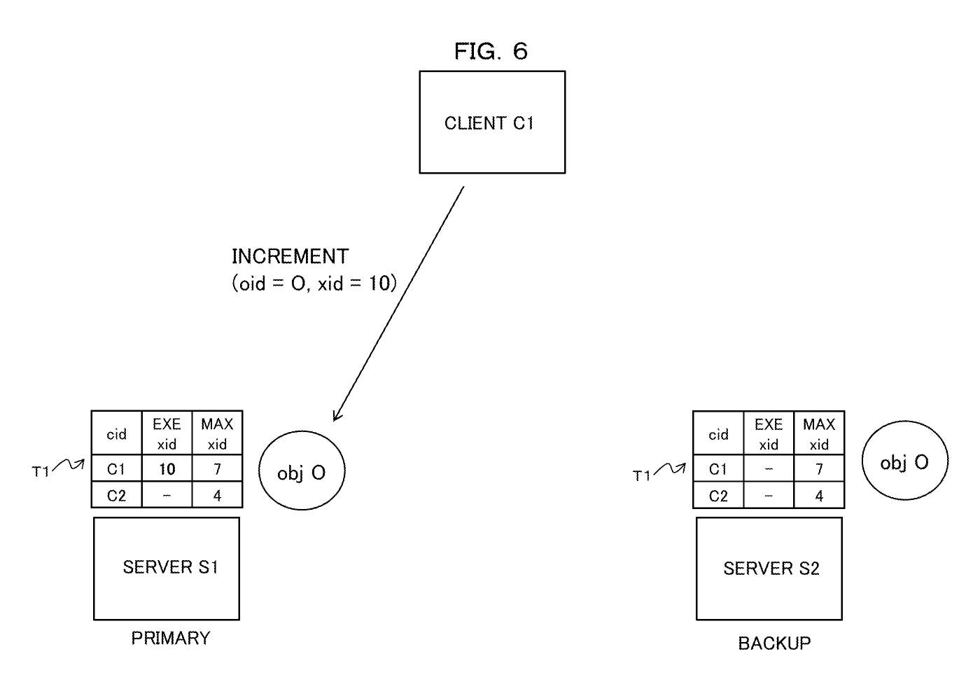

In the state illustrated in FIG. 5, the executing transaction ID (EXE xid) is not present, and the maximum executed transaction ID (MAX xid=7) is smaller than the transaction ID (Xid=10) added to the request. The determination unit 22 determines that the received request is to be executed. The control unit 23 causes the processing unit 21 to execute the command for the received request, and the processing unit 21 executes the INCREMENT command for the received request. As illustrated in FIG. 6, in the primary server S1, the determination unit 22 stores 10 for the executing transaction ID in association with the client C1 in the control information T1 (EXE xid=10).

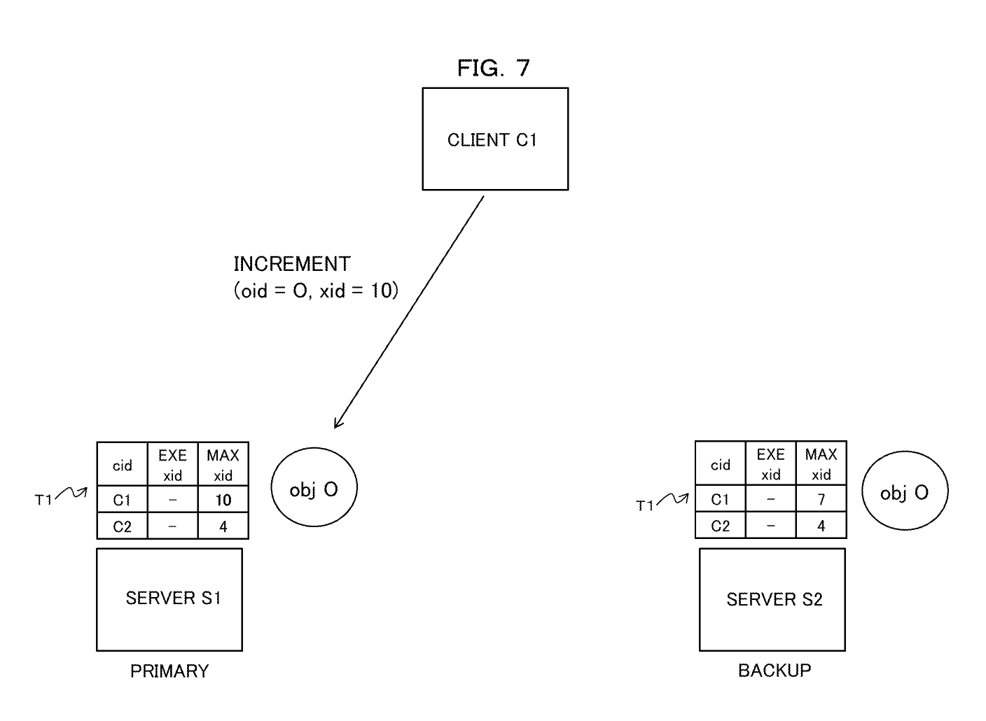

In the primary server S1, when the processing unit 21 completes executing the INCREMENT command for the request (xid=10), the determination unit 22 updates the control information T1 as illustrated in FIG. 7. That is, the determination 22 stores 10 for the maximum executed transaction ID in association with the client C2 in the control information T1, and correspondingly deletes the value of the executing transaction ID.

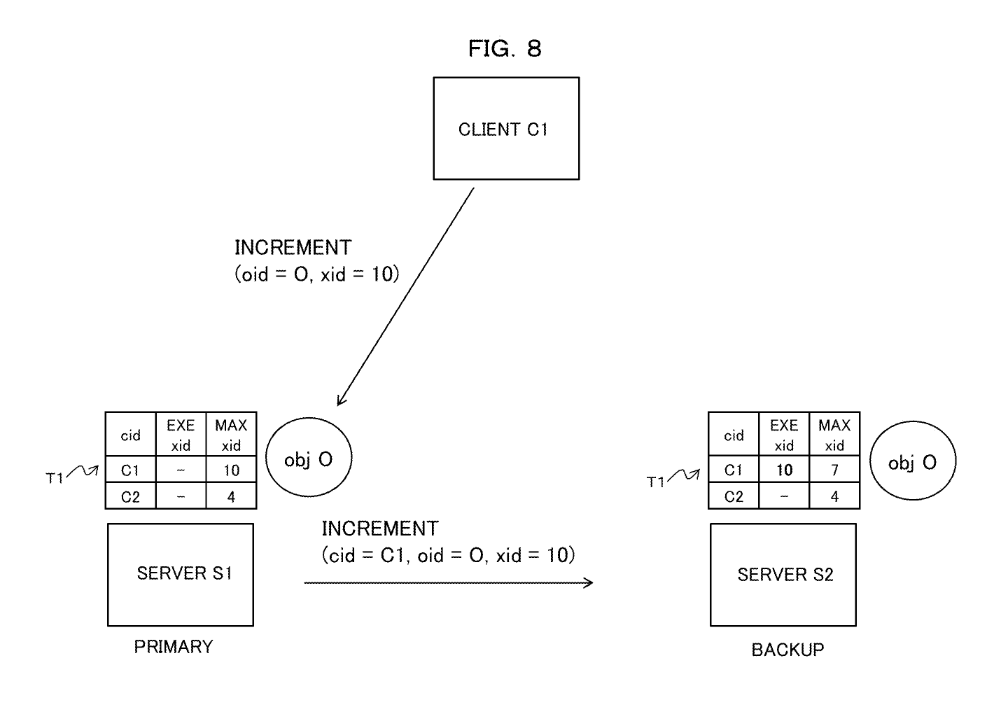

As illustrated in FIG. 8, the redundant processing unit 25 in the primary server S1 forwards the request received from the client C1 to the backup server S2. The request forward is added with the client ID (cid=1) of the client C1 as the transmission source.

In the backup server S2 having received the forwarded request, the determination unit 22 compares the transaction ID (Xid=10) added to the request with the executing transaction ID (EXE xid) or the maximum executed transaction ID (MAX xid) in the control information T1.

In the state illustrated in FIG. 7, in the backup server S2, the executing transaction ID (EXE xid) is not present, and the maximum executed transaction ID (MAX xid=7) is smaller than the transaction ID (Xid=10) added to the request. Thus, in the backup server S2, the determination unit 22 determines that the received request is to be executed. The control unit 23 causes the processing unit 21 to execute the command for the received request, and the processing unit 21 executes the INCREMENT command for the received request. In the backup server S2, the determination unit 22 stores 10 for the executing transaction ID in association with the client C1 in the control information T1 (EXE xid=10).

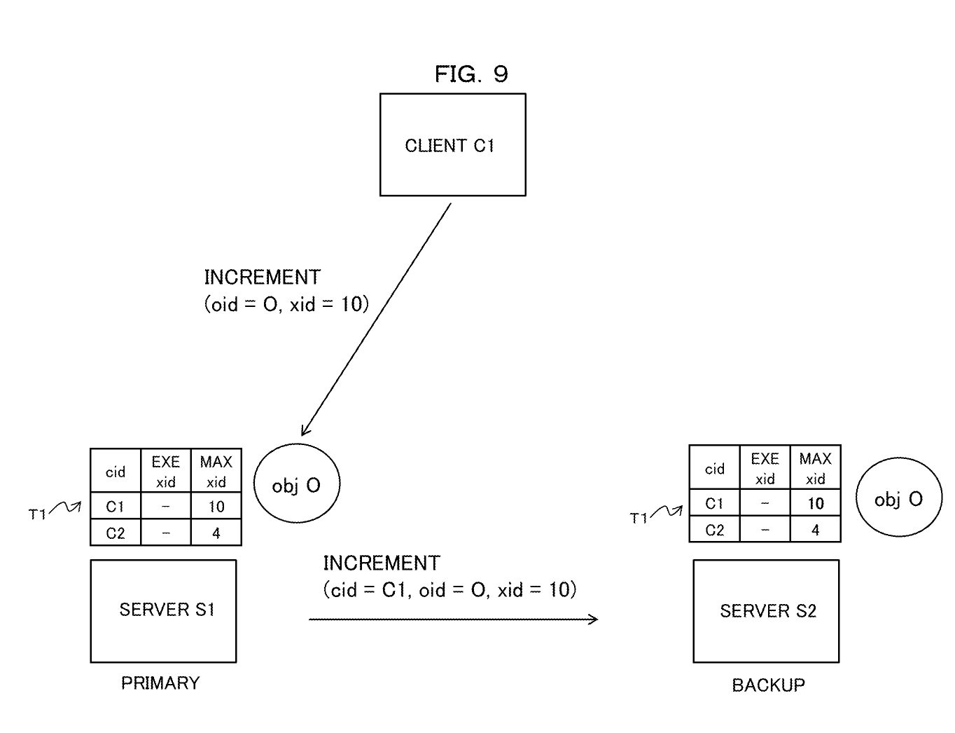

In the backup server S2, when the processing unit 21 completes executing the INCREMENT command for the request (xid=10), the determination unit 22 updates the control information T1 as illustrated in FIG. 9. That is, the determination unit 22 stores 10 for the maximum executed transaction ID in association with the client C1 (MAX xid=10) and correspondingly deletes the value of the executing transaction ID.

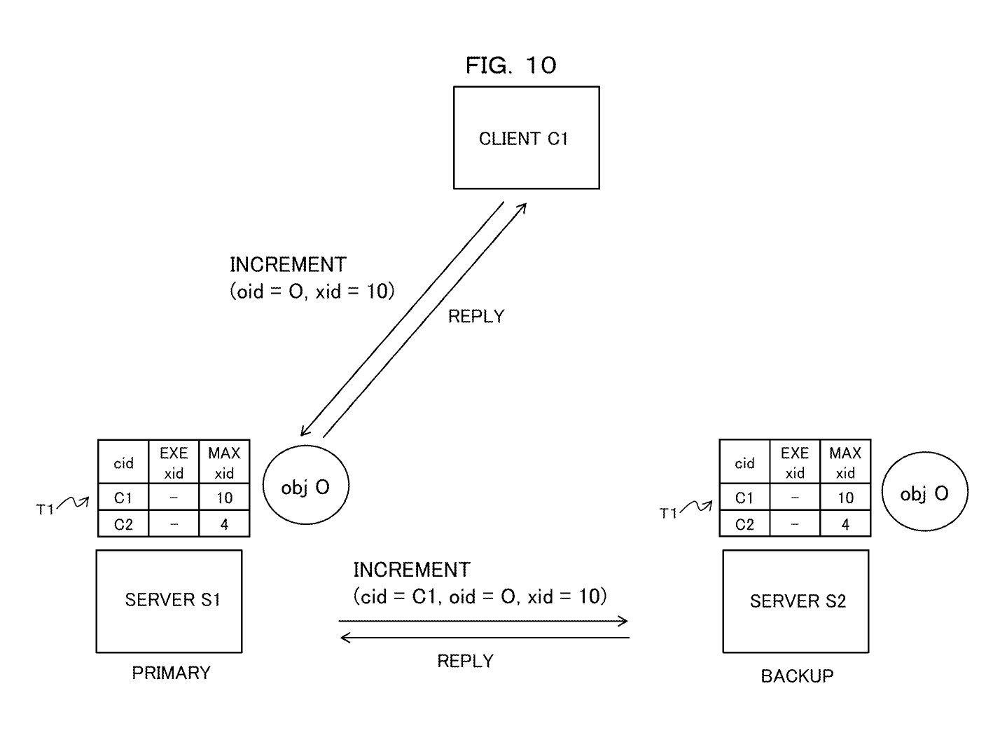

As illustrated in FIG. 10, the transmission unit 24 in the primary server S1 transmits a reply to the client C1 as the transmission source of the request. The reply contains success of the command execution for the request, the execution result, and the like, for example. The backup server S2 transmits a reply to the primary server S1 as a forward source of the request.

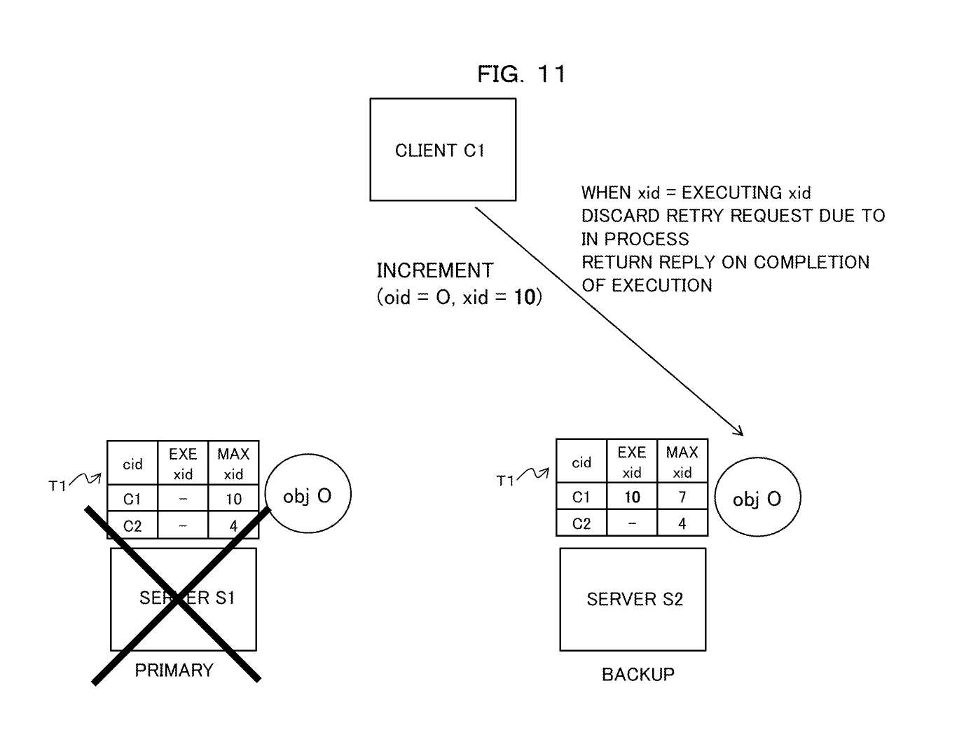

Processing when the primary server S1 breaks down will be described below with reference to FIGS. 11 to 13.

In the example illustrated in FIG. 11, it is assumed that in the state illustrated in FIG. 8, the primary server S1 breaks down while the processing unit 21 in the backup server S2 is executing the INCREMENT command (xid=10) for the request forwarded from the primary server S1.

The management server 101 detects the breakdown of the primary server S1, and sets the backup server S2 as a new primary server. The management server 101 notifies, to each client C, that the server S2 is a new primary server (primary server S2).

Provided that, the server S1 is denoted as “primary” and the server S2 is denoted as “backup” for convenience in FIGS. 11 to 13.

A reply for the request is not transmitted from the primary server S1 to the client C1 due to the breakdown of the primary server S1.

The client C1 detects a time-out error when a predetermined time has elapsed since the request (xid=10) was transmitted to the primary server S1 without receiving the reply for the request. The client C1 having detected the time-out error issues a retry request for the same request (xid=10) to the new primary server S2. That is, the client C1 issues the request (xid=10) for the INCREMENT command for the object 0 to the primary server S2.

In the primary server S2, the determination unit 22 compares the transaction ID (Xid=10) added to the request with the executing transaction ID (EXE xid) or the maximum executed transaction ID (MAX xid) in the control information T1.

In the state illustrated in FIG. 11, the transaction ID (Xid=10) added to the request is equal to the executing transaction ID (EXE xid=10).

The determination unit 22 determines that the processing unit 21 is executing the received request. The control unit 23 does not cause the processing unit 21 to process the command for the received request, and discards the command. Thereby, the processing 21 does not execute the same command in an overlapped manner. In the primary server S2, after the processing unit 21 completes the executing command, the transmission unit 24 transmits the execution result of the command as a reply to the client C1.

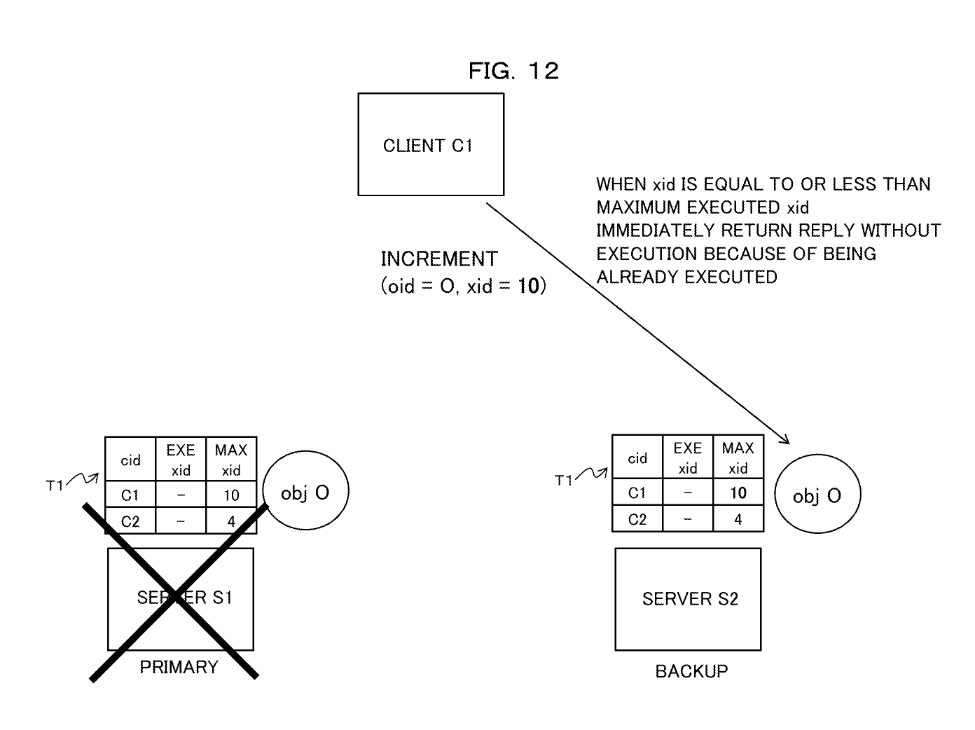

Further, in the example illustrated in FIG. 12, it is assumed that in the state illustrated in FIG. 9, the primary server S1 breaks down after the processing unit 21 in the backup server S2 completes executing the INCREMENT command (xid=10) for the request forwarded from the primary server S1.

That is, in the backup server S2, the determination unit 22 stores 10 for the maximum executed transaction ID in association with the client C1 (MAX xid=10), and correspondingly deletes the value of the executing transaction ID, and consequently the primary server S1 breaks down while the control information T1 is updated.

The management server 101 detects the breakdown of the primary server S1, and sets the backup server S2 as a new primary server. The management server 101 notifies, to the client C1, that the server S2 is a new primary server (primary server S2).

Since the primary server S1 breaks down, the reply for the request is not transmitted from the primary server S1 to the client C1.

The client C1 does not receive the reply for the request after a predetermined time has elapsed since the request (xid=10) was transmitted, and then detects a time-out error. The client C1 having detected the time-out error issues a retry request for the same request (xid=10) to the new primary server S2. That is, the client C1 issues the request (xid=10) for the INCREMENT command for the object 0 to the primary server S2.

In the primary server S2, the determination unit 22 compares the transaction ID (Xid=10) added to the request with the executing transaction ID (EXE xid) or the maximum executed transaction ID (MAX xid) in the control information T1.

In the state illustrated in FIG. 12, the transaction ID (Xid=10) added to the request is equal to the maximum executed transaction ID (MAX xid=10).

The determination unit 22 determines that the received request has been executed by the processing unit 21. The control unit 23 does not cause the processing unit 21 to process the command for the received request. Thereby, the processing unit 21 does not execute the same command in an overlapped manner. The transmission unit 24 returns the execution result of the received request as a reply to the transmission source of the request.

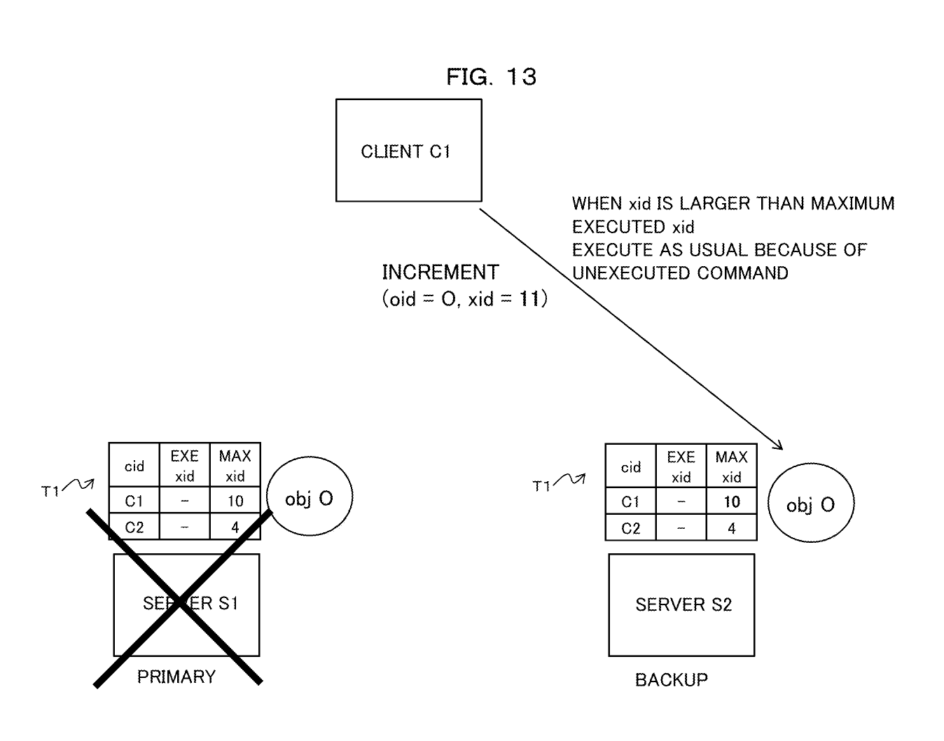

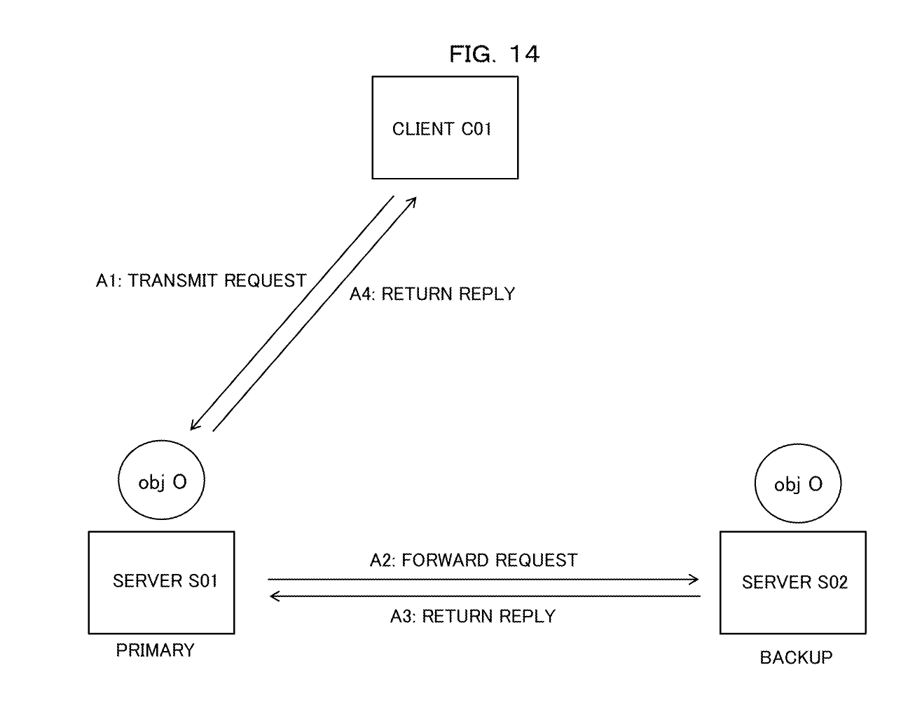

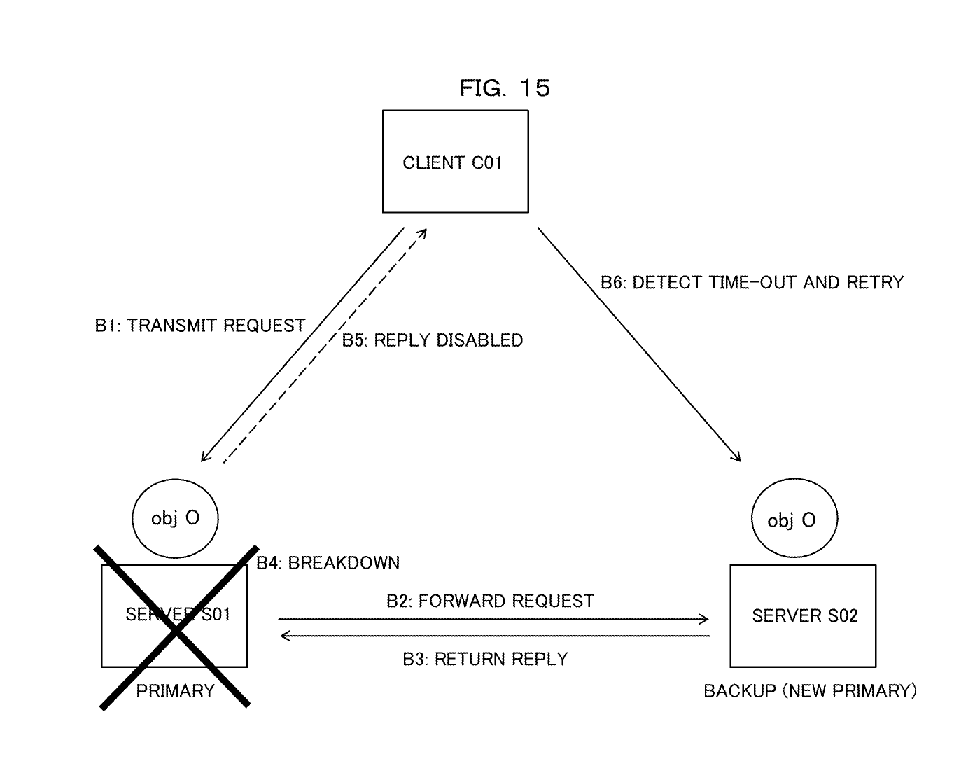

Further, in the example illustrated in FIG. 13, it is assumed that in the state illustrated in FIG. 9, the primary server S1 breaks down after the processing unit 21 in the backup server S2 completes executing the INCREMENT command (xid=10) for the request forwarded from the primary server S1 and before the primary server S1 forwards a new request (xid=11) to the backup server S2.

That is, in the backup server S2, the determination unit 22 stores 10 for the maximum executed transaction ID in association with the client C1 in the control information T1 (MAX xid=10). Further, the determination 22 correspondingly deletes the value of the executing transaction ID. In this way, it is assumed that the primary server S1 breaks down while the determination unit 22 updates the control information T1.

The management server 101 detects the breakdown of the primary server S1, and sets the backup server S2 as a new primary server. The management server 101 notifies, to the client C1, that the server S2 is a new primary server (primary server S2).

The reply for the request is not transmitted from the primary server S1 to the client C1 due to the breakdown of the primary server S1.

The client C1 does not receive the reply for the request after a predetermined time has elapsed since the request (xid=11) was transmitted, and thus detects a time-out error. The client C1 having detected the time-out error issues a retry request for the same request (xid=11) to the new primary server S2. That is, the client C1 issues the request (xid=11) for the INCREMENT command for the object 0 to the primary server S2.

In the primary server S2, the determination unit 22 compares the transaction ID (Xid=11) added to the request with the executing transaction ID (EXE xid) or the maximum executed transaction ID (MAX xid) in the control information T1.

In the state illustrated in FIG. 13, the transaction ID (Xid=11) added to the request is larger than the maximum executed transaction ID (MAX xid=10).

The determination unit 22 determines that the received request has not been executed by the processing unit 21. The control unit 23 causes the processing unit 21 to process the command for the request which has not been executed by the processing unit 21. The transmission unit 24 returns the execution result for the received request as a reply to the transmission source of the request.

In this way, with the exemplary storage system 1 according to the embodiment, in the server S, the maximum executed transaction ID indicating the request last processed by the processing unit 21 is stored as the control information T1. Further, the transaction ID is processing order information indicating a request transmission order.

The determination unit 22 compares the transaction ID of the received request with the maximum executed transaction ID in the control information T1 thereby to determine whether the received request has been executed in the server S. Then, when the transaction ID of the received request is equal to or less than the maximum executed transaction ID, the control unit 23 prevents the processing unit 21 from processing the command for the received request.

When the transaction ID of the received request is equal to or less than the maximum executed transaction ID, the command for the request has been executed, thereby preventing the processing unit 21 from executing the command in an overlapped manner.

The execution result by the processing unit 21 is stored in the RAM 202 or the like, and the transmission unit 24 transmits the execution result of the command by the processing unit 21 stored in the RAM 202 or the like as a reply to the transmission source of the request. Thereby, the processing unit 21 can transmit the execution result of the processed command as a reply without executing the command in an overlapped manner.

Further, the executing transaction ID or the maximum executed transaction ID is stored as the control information T1 for each object for the request, and thus a command for a request for a different object can be executed in parallel in the server S.

Information associating the executing transaction ID and the maximum executed transaction ID is used as the control information T1 for the client ID for each object, thereby realizing the overlapped management of the requests with a small amount of data. Further, even when the number of requests from each client C increases and the server S enters a high-load state, the data on the control information T1 does not disappear and overlapped execution of the requests can be accurately prevented.

The disclosed technique is not limited to the above embodiment, and can be variously modified and performed without departing from the scope of the present embodiment. Each structure and each processing in the present embodiment may be selected or combined as needed.

Further, the present invention is not limited to the above embodiment, and can be variously modified and performed without departing from the scope of the present embodiment.

For example, the above embodiment exemplifies that the storage system 1 includes two clients C1 and C2, and two servers S1 and S2, but is not limited thereto. That is, one, or three or more clients C may be provided and three or more servers S may be provided.

Further, the above embodiment exemplifies the storage system 1 in which each server S manages the storage device 208, but is not limited thereto and may be an information processing system other than the storage system 1.

The above disclosure enables the present embodiment to be performed and manufactured by those skilled in the art.

With the disclosed technique, there is an advantage of preventing overlapped processing of a request.

All examples and conditional language recited herein are intended for the pedagogical purposes of aiding the reader in understanding the invention and the concepts contributed by the inventor to further the art, and are to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A processor comprising:
a processing unit that processes received requests;
a storage unit that stores order information added to the last-processed request among the requests processed by the processing unit as final request information;
a determination unit that determines whether the received request has been processed with reference to the final request information based on the order information added to the received request; and
a control unit that, when the determination unit determines that the received request has been processed, prevents the received request from being processed by the processing unit.

2. The processor according to claim 1, comprising:
a processing result storage unit that stores processing results of the requests by the processing unit; and
a transmission unit that, when the determination unit determines that the received request has been processed, transmits the processing result stored in the processing result storage unit to a request source.

3. The processor according to claim 1, wherein the storage unit stores the final request information for each object corresponding to the final request information.

4. The processor according to claim 1,
wherein the storage unit stores order information added to a request being processed by the processing unit as in-process request information,
the determination unit determines whether the received request is being processed with reference to the in-process request information based on the order information added to the received request, and
when the determination unit determines that the received request is being processed, the control unit prevents the received request from being processed by the processing unit.

5. The processor according to claim 4,
wherein when the determination unit determines that the received request is being processed, after the processing unit completes processing the in-process request, the transmission unit transmits a processing result of the processing-completed request to a request source.

6. The processor according to claim 4,
wherein the storage unit stores the in-process request information for each object for the in-process request information.

7. A computer readable recording medium recording a program therein, the program causing a computer to execute the processing of:
storing order information added to the last-processed request among processed requests as final request information;
determining whether the received request has been processed with reference to the final request information based on the order information added to the received request; and
when the received request is determined as processed, preventing the received request from being processed.

8. The computer readable recording medium recording the program therein according to claim 7, the program causing the computer to execute the processing of:
when the received request is determined as processed, transmitting the processing result stored in the processing result storage unit to a request source.

9. The computer readable recording medium recording the program therein according to claim 7, the program causing the computer to execute the processing of:
storing the final request information for each object corresponding to the final request information in the storage unit.

10. The computer readable recording medium recording the program therein according to claim 7, the program causing the computer to execute the processing of:
storing order information added to an in-process request as in-process request information in the storage unit;
determining whether the received request is being processed with reference to the in-process request information based on the order information added to the received request; and
when the received request is determined as being processed, preventing the received request from being processed.

11. The computer readable recording medium recording the program according to claim 10, causing the computer to execute the processing of, when the received request is determined as being processed, after completing processing the in-process request, transmitting a processing result of the processing-completed request to a request source.

12. The computer readable recording medium recording the program according to claim 10 therein, the program causing the computer to execute the processing of storing the in-process request information for each object for the in-process request information in the storage unit.

13. A processing system comprising:
a request transmission unit that adds order information indicating an order of requests to a request, and transmits the request;
a processing unit that processes received requests;
a storage unit that stores order information added to the last-processed request among the requests processed by the processing unit as final request information;
a determination unit that determines whether the received request has been processed with reference to the final request information based on the order information added to the received request; and
a control unit that, when the determination unit determines that the received request has been processed, prevents the received request from being processed by the processing unit.

14. The processing system according to claim 13, comprising:
a processing result storage unit that stores processing results of the requests by the processing unit; and
a transmission unit that, when the determination unit determines that the received request has been processed, transmits the processing result stored in the processing result storage unit to a request source.

15. The processing system according to claim 13, wherein the storage unit stores the final request information for each object corresponding to the final request information.

16. The processing system according to claim 13,
wherein the storage unit stores order information added to a request being processed by the processing unit as in-process request information,
the determination unit determines whether the received request is being processed with reference to the in-process request information based on the order information added to the received request, and
when the determination unit determines that the received request is being processed, the control unit prevents the received request from being processed by the processing unit.

17. The processing system according to claim 16,
wherein when the determination unit determines that the received request is being processed, after the processing unit completes processing an in-process request, the transmission unit transmits a processing result of the processing-completed request to a request source.

18. The processing system according to claim 16,
wherein the storage unit stores the in-process request information for each object for the in-process request information.
